(19) United States
(12) Patent Application Publication
(10) Pub. No.: US 2011/0175711 A1
(43) Pub. Date: Jul. 21, 2011

(54) POWER CONTROL DEVICE

(76) Inventors: Hsin-Fu KUO, Taipei City (TW); Yu-Sheng Yen, Taipei City (TW)

(21) Appl. No.: 12/689,559

(22) Filed: Jan. 19, 2010

(51) Int. Cl. G05B 11/01

(52) U.S. Cl. 340/12.32

(57) ABSTRACT

A power control device includes an electric outlet strip having female receptacles for providing power supply to electric products being respectively connected thereto and a signal transmission and receiving module adapted for receiving an external control signal, and a control module having a signal adapter controllable to provide a control signal to the signal transmission and receiving module for controlling the control unit of the electric outlet strip to switch on/off each female receptacle and a connection interface for communication with an external electronic apparatus operable to control the signal adapter in providing a control signal to the signal transmission and receiving module for controlling a control unit of the electric outlet strip to switch on/off each female receptacle.

### BACKGROUND OF THE INVENTION

1. Field of the Invention

The present invention relates to power control technology and more particularly, to a power control device, which comprises an electric outlet strip for providing power supply to electric products, and a control module controllable by an external electronic apparatus to transmit a control signal to a control unit in the electric outlet strip by a wired or wireless method, causing the control unit to switch on/ off each female receptacle subject to a predetermined setting.

2. Description of the Related Art

Following the progress of modern technology, the living quality has been greatly improved. Nowadays, many different electric and electronic products, such as desk computer, notebook computer, PDA, copier, fax machine, printer, TV, audio system, air conditioner, refrigerator, washing machine, electric fan, electric cooker and etc. are used in every family or office, assisting people to do many different works rapidly and safety and bringing convenience and comfort to people. Further, following development of technology, advanced electric and electronic products are continuously promoted to serve people. When using many different electric and/or electronic products in a family or office, the limited number of available wall electric outlets in the family or office may be insufficient. In this case, an extension electric outlet strip may be necessary. An early design of electric outlet strip simply provides multiple female receptacles for the connection of electric/electronic products. When using an early design of electric outlet strip, the user must connect the electric plug of the power cable of the electric outlet strip to a city power supply outlet and then connect the electric plug of the power cord of each electric/electronic product to be used to one of the female receptacles. When not in use, the user must disconnect the electric plug of the power cable of the electric outlet strip from the city power supply outlet. It is inconvenient to frequently plug and unplug the electric plug of the power cable of the electric outlet strip. To eliminate this problem, electric outlet strips with manual switch means for controlling on/off of each female receptacle thereof are created. However, this design of electric outlet strip is still not satisfactory in function due to the following disadvantages:

1. When wishing to turn on/off each installed electric/electronic product, the user must switch on/off the respective switch at the electric outlet strip. The user may forget to switch on/off the switches at the electric outlet strip due to busy work, causing the electric/electronic products to overwork or not be able to work.

2. When the user is taking time off from work, on vocation or traveling outside, he (she) cannot control the power supply of the electric/electronic products in his (her) home or family. If the user forgets to check the installation before going out of the house or office, the electric/electronic products may be unable to work normally. To keep the electric/electronic products in standby mode for a long period of time will cause waste of power supply.

Therefore, it is desirable to provide an electric outlet strip, which eliminates the aforesaid problems and enables the user to control on/off of every installed electric/electronic product effectively, assuring a high level of safety and normal functioning of installed electric/electronic products.

### SUMMARY OF THE INVENTION

The present invention has been accomplished under the circumstances in view. It is one object of the present invention to provide an electric outlet strip, which eliminates the aforesaid problems.

To achieve this and other objects of the present invention, an electric outlet strip comprises an electric outlet strip having female receptacles for providing power supply to electric products being respectively connected thereto and a signal transmission module adapted for receiving an external control signal, and a control module having a signal adapter unit controllable to provide a control signal to the signal transmission and receiving module for controlling the control unit of the electric outlet strip to switch on/off each female receptacle and a connection interface for communication with an external electronic apparatus operable to make functioning settings such as executing signal setting, editing, time setting and to control the signal adapter in providing a control signal to the signal transmission and receiving module for controlling a control unit of the electric outlet strip to switch on/off each female receptacle.

Further, the communication between the signal adapter unit of the control module and the signal transmission and receiving module of the electric outlet strip can be done by means of a wired method or a wireless method. Thus, the use of the electric outlet strip is free from the constraint of space and distance.

Further, the control module can be connected to any of a variety of external electronic apparatus (such as desk computer, notebook computer, PAD or the like) by means of the connection interface. Thus, a person can operate the external electronic apparatus to control the operation of the control module subject to a predetermined setting, thereby driving the control unit of the electric outlet strip to switch on/off each female receptacle respectively at a respective predetermined time.

Further, sensors may be installed in the electric outlet strip and respectively arranged between each two adjacent female receptacles for detecting an accidental contact of an external object (static electricity produced by the body skin or finger of a person, water drop or metal object) and driving the control unit of the electric outlet strip to switch off the respective female receptacles upon detection of an accidental contact signal.

### BRIEF DESCRIPTION OF THE DRAWINGS

FIG. 1 is a perspective view of a power control device according to the present invention.

FIG. 2 is a perspective view of an alternate form of the power control device according to the present invention.

FIG. 3 is a circuit block diagram of the power control device shown in FIG. 1.

FIG. 4 is a circuit block diagram of the power control device shown in FIG. 2.

FIG. 5 is a schematic drawing showing one application example of the present invention.

FIG. 6 is a schematic drawing showing another application example of the present invention.

### DETAILED DESCRIPTION OF THE PREFERRED EMBODIMENT

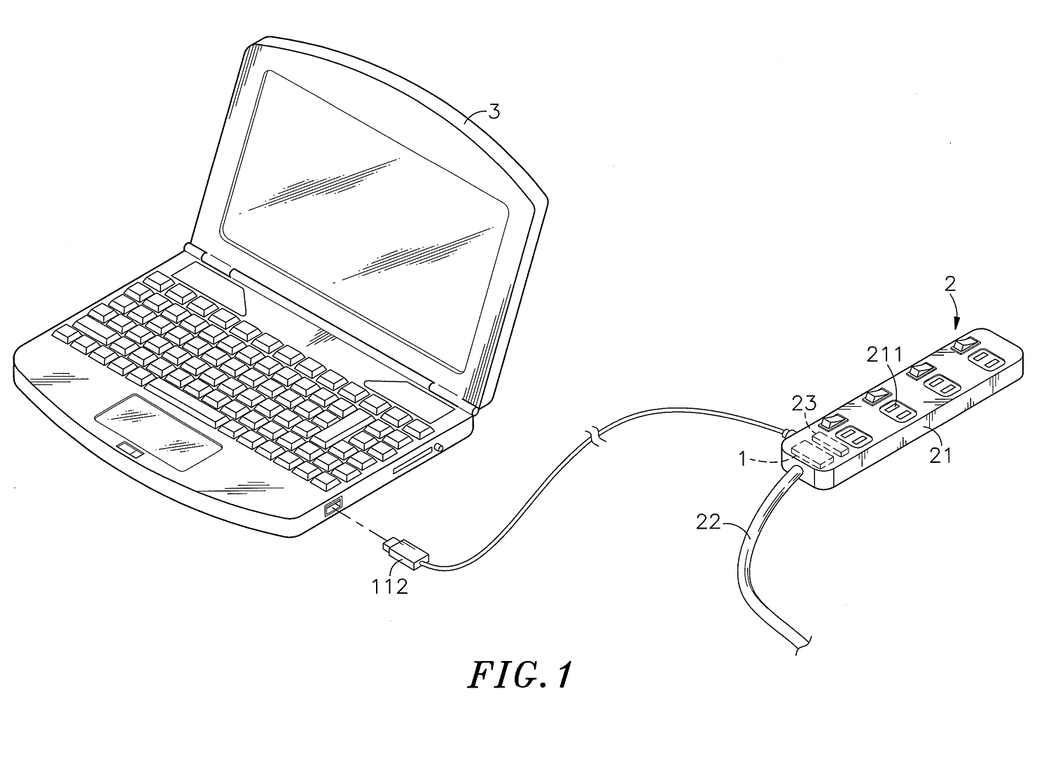

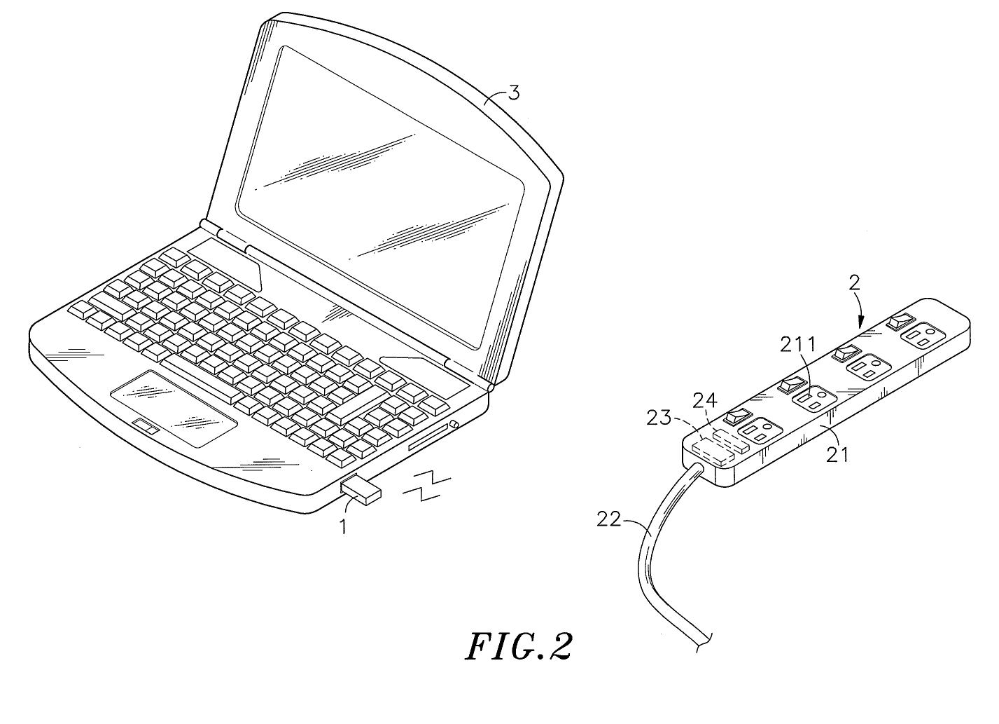

Referring to FIGS. 1-4, a power control device in accordance with the present invention is shown comprising a control module 1 and an electric outlet strip 2.

The control module 1 comprises a circuit board 11 having carried thereon a control unit 111, a connection interface 112, a signal adapter unit 113 and a circuit layout (not shown). The control unit 111 has operation, control and execution programs built therein.

The electric outlet strip 2 comprises an electrically insulative housing 21, a plurality female receptacles 211 arranged in the electrically insulative housing 21, a power cable 22, which has its one end electrically connected with the female receptacles 211 and its other end extended out of the electrically insulative housing 21 and terminating in an electric plug (not shown) for connection to a city power supply outlet to obtain AC power supply, a control unit 23 mounted in the electrically insulative housing 21 and electrically connected with the female receptacles 211 and a signal transmission module 24 mounted in the electrically insulative housing 21 and electrically connected with the control unit 23.

During application, the control unit 111 of the circuit board 11 of the control module 1 controls the signal adapter unit 113 to transmit a signal to the signal transmission and receiving module 24 of the electric outlet strip 2. Upon receipt of the signal from the control module 1 the signal transmission and receiving module 24 sends the received signal to the control unit 23, enabling the control unit 23 to control on/off status of the female receptacles 211. Further, the control module 1 is electrically connectable to an external electronic apparatus 3 by means of the connection interface 112. After connection of the connection interface 112 to an external electronic apparatus 3, the external electronic apparatus 3 can control the control unit 111 of the circuit board 11 of the control module 1 to run operations, such as input, delete, setting, editing, time setting and execution, thereby monitoring or controlling on/off status of the female receptacles 211 of the electric outlet strip 2.

Further, the control unit 111 of the circuit board 11 of the control module 1 can be a CPU, system-on-a-chip (SoC), IC or microprocessor designed to perform arithmetic and logic operations including adding, subtracting, comparing two numbers, and fetching numbers from one area to another. Further, the connection interface 112 of the circuit board 11 of the control module 1 can be any of a variety of signal transmission interface, such as USB (universal serial bus) or RS-232 for connection to a matching interface of an external electronic apparatus 3 that can be desk computer, notebook computer, PAD or the like that is capable of controlling the control module 1 to run setting, editing and executing operations.

Further, the female receptacles 211 of the electric outlet strip 2 can be two-hole outlets or three-hole outlets. Further, the female receptacles 211 of the electric outlet strip 2 can be designed to have the same size. Alternatively, female receptacles 211 of the electric outlet strip 2 can be designed to have different sizes. Further, manual on/off switches may be installed in the electrically insulative housing 21 of the electric outlet strip 2 for manual operation to switch on/off the female receptacles 211 respectively by the user. Further, sensor means may be installed in the electrically insulative housing 21 of the electric outlet strip 2 and respectively arranged between each two adjacent female receptacles 211 for detecting an accidental contact of an external object (static electricity produced by the body skin or finger of a person, water drop or metal object) and driving the control unit 23 to switch off the respective female receptacles 211 upon detection of an accidental contact signal. Further, the control unit 23 of the electric outlet strip 2 can be a relay, solenoid switch, switching device or the like that is capable of switching on/off a circuit.

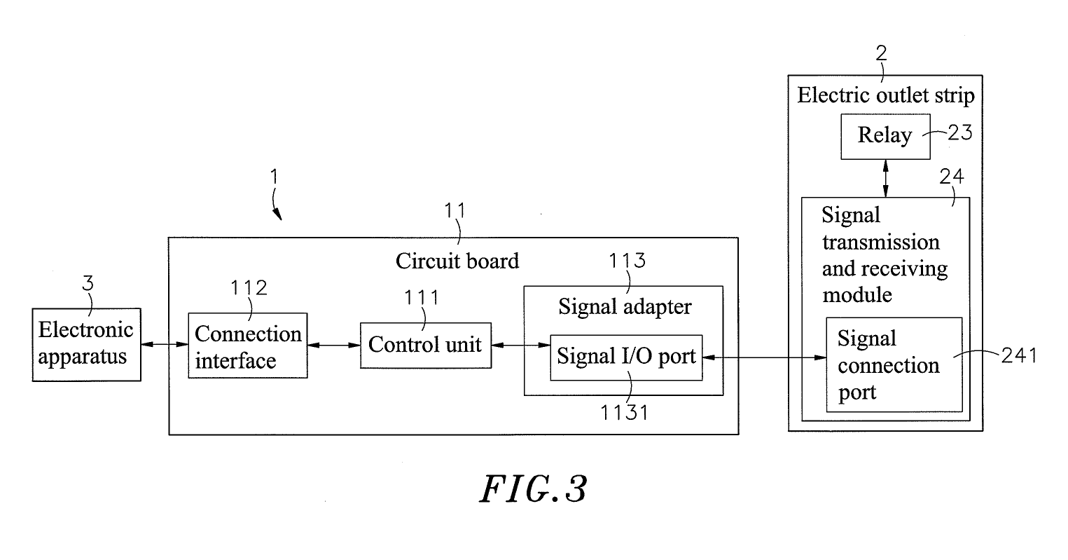

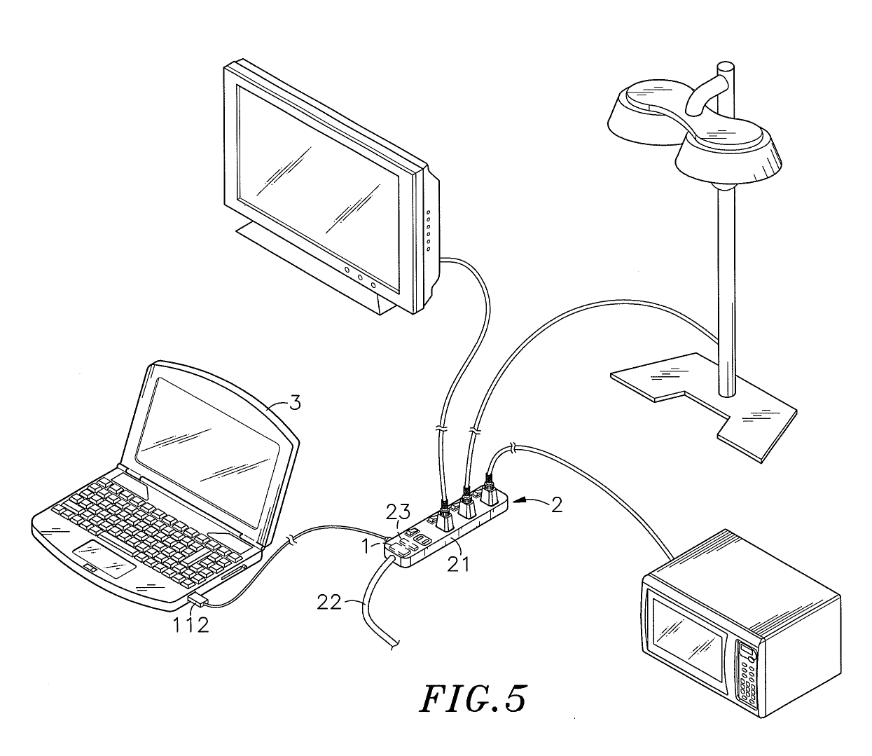

Referring to FIGS. 3, 4 and 5, the signal adapter 113 of the circuit board 11 of the control module 1 can be electrically connected to the signal transmissionmodule 24 of the electric outlet strip 2 in a wired manner for wired signal transmission. In this case, as shown in FIG. 3, the signal adapter 113 of the circuit board 11 of the control module 1 can be made having a signal input/output port 1131, and the signal transmission and receiving module 24 of the electric outlet strip 2 can be made having a signal connection port 241 for the connection of the signal I/O port 1131 of the signal adapter 113 of the circuit board 11 of the control module 1. Further, the signal I/O port 1131 and the compatible signal connection port 241 can be USB or RS-232 male/female connectors.

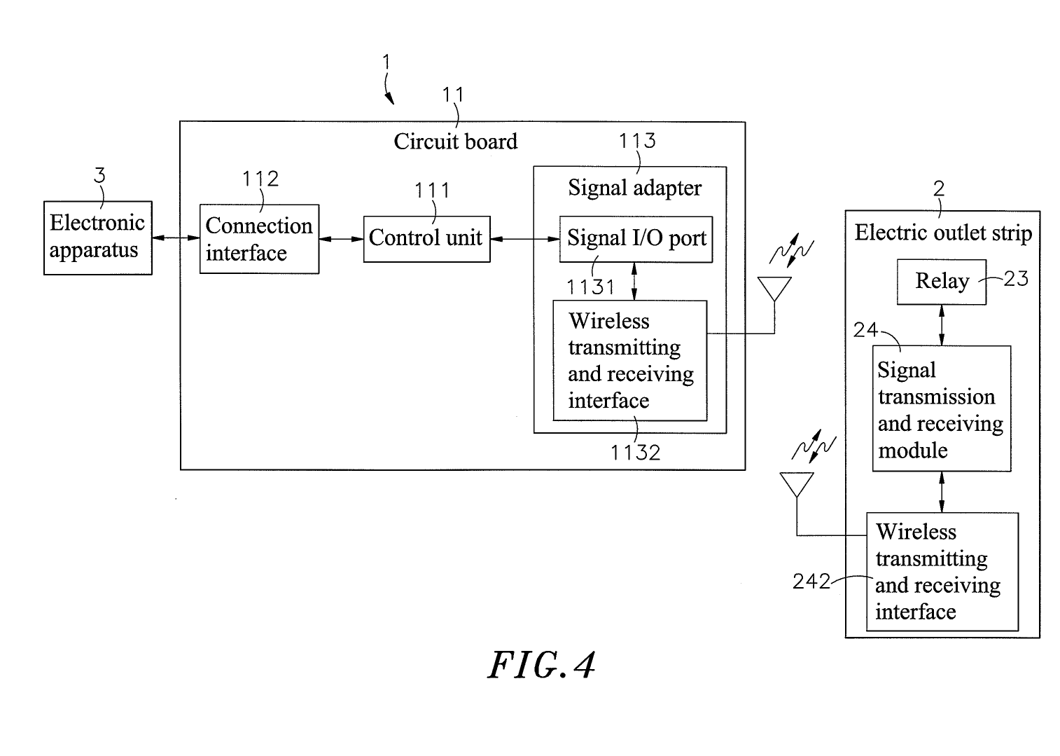

Further, the connection between the signal adapter 113 of the circuit board 11 of the control module 1 and the signal transmission and receiving module 24 of the electric outlet strip 2 can be done in a wireless manner for wireless signal transmission. In this case, as shown in FIG. 4, the signal adapter 113 of the circuit board 11 of the control module 1 can be made having a wireless transmitting and receiving interface 1132 electrically connected with the signal input/output port 1131 thereof for transmitting a signal to the external wirelessly electrical devices, such as power control device and the signal transmission and receiving module 24 of the electric outlet strip 2 can be made having a wireless transmitting and receiving interface 242 for receiving a wireless signal from the wireless transmitting and receiving interface 1132 of the signal adapter 113 of the circuit board 11 of the control module 1. Further, the wireless transmitting and receiving interface 1132 and the wireless transmitting and receiving interface 242 can be RF (radio frequency signal interfaces, infrared signal interfaces, or Bluetooth signal interfaces.

The circuit board 11 of control module 1 is controllable to transmit a control signal to the signal transmission and receiving module 24 of the electric outlet strip 2 by means of the signal adapter 113. Further, the circuit board 11 of control module 1 is electrically connectable to an external electronic apparatus 3 through the connection interface 112 so that the connected external electronic apparatus 3 can be operated to transmit an executing program, setting program, editing program or time setting control signal to the control unit 111 of the circuit board 11 through the connection interface 112, for enabling the control signal to be transmitted by the control unit 111 to the signal adapter unit 113. At this time, the signal adapter 113 transmits a connection signal to the signal transmission and receiving module 24 of the electric outlet strip 2, which, in turn, will transmit the signal to the control unit 23 to switch on the female receptacles 211 for the transmission of power supply from the power cable 22 to the electric products being connected to the female receptacles 211 for working. When one female receptacle 211 is switched on, a corresponding feedback signal, i.e., ON signal is produced and sent by the control unit 23 to the signal transmission and receiving module 24 for enabling the signal transmission and receiving module 24 to feed back the ON signal to the signal adapter 113 of control module 1. Upon receipt of the ON signal, the signal adapter 113 transmits the signal to the control unit 111, for enabling the ON signal to be further transmitted by the control unit 111 to the connected external electronic apparatus 3 through the connection interface 112. Thus, the connected external electronic apparatus 3 can effectively control the on status of every female receptacle 211 of the electric outlet strip 2.

When the control unit 111 of the control module 1 is controlled to transmit a disconnection signal through the signal adapter 113 to the signal transmission and receiving module 24 of the electric outlet strip 2, the signal transmission and receiving module 24 transmits the disconnection signal to the control unit 23 of the electric outlet strip 2 to switch off the connection between the female receptacles 211 and the power cable 22, thereby stopping the supply of power supply to the female receptacles 211 and the respective electric products. When one female receptacle 211 is switched off, a corresponding feedback signal, i.e., OFF signal is produced and sent by the control unit 23 to the signal transmission and receiving module 24 for enabling the signal transmission and receiving module 24 to feed back the Off signal to the signal adapter 113 of control module 1. Upon receipt of the Off signal, the signal adapter 113 transmits the signal to the control unit 111, for enabling the Off signal to be further transmitted by the control unit 111 to the connected external electronic apparatus 3 through the connection interface 112. Thus, the connected external electronic apparatus 3 can effectively control the off status of every female receptacle 211 of the electric outlet strip 2.

Further, the electric products to be connected to the female receptacles 211 in the electrically insulative housing 21 of the electric outlet strip 2 can be home electric appliances such as TV, electric fan, audio system, video recorder and player, aquarium system, refrigerator or washing machine, or office machines such as copier, fax machine, printer or shredder. The electric product that is connected to one female receptacle 211 can communicate with the signal adapter 113 of the control module 1 through the signal transmission and receiving module 24 of the electric outlet strip 2, and the external electronic apparatus 3 that is connected to the connection interface 112 of the control module 1 can be operated to control the control module 1 to run setting, editing or control of an executing program or setting of time. Subject to the control of the external electronic apparatus 3, the signal adapter 113 is driven to transmit a control signal to the signal transmission and receiving module 24 of the electric outlet strip 2, thereby controlling the control unit 23 of the electric outlet strip 2 to switch on/off each of the female receptacles 211 according to a respective set time. When switching on/off one female receptacle 211 of the electric outlet strip 2, a corresponding signal is fed back for management control. Subject to the application of the power control device, installed electric products are respectively switched on/off subject to predetermined set times, and therefore the use of every installed electric product is effectively controlled, avoiding an overwork of installed electric products to lower the performance or a non-working status of installed electric products due to a non-startup mistake.

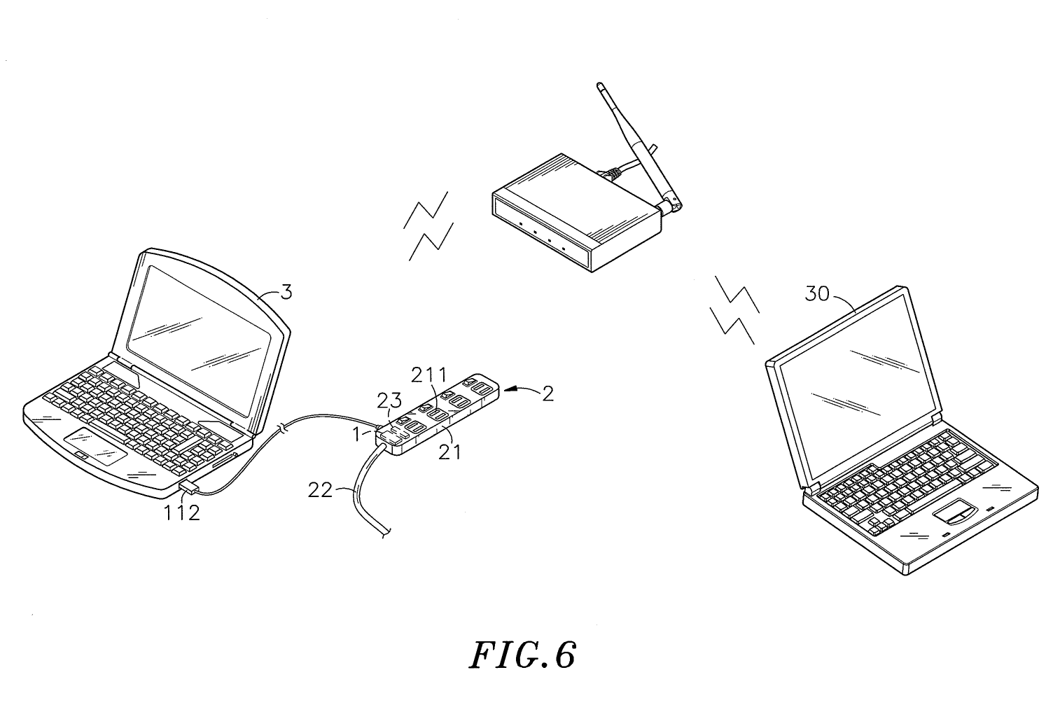

Referring to FIGS. 3, 4 and 6, after connection of an external electronic apparatus 3 with the connection interface 112 of the circuit board 11 of the control module 1, the external electronic apparatus 3 can communicate with a remote electronic apparatus 30 through the Internet, so that the remote electronic apparatus 30 can control the proximal electronic apparatus 3 in operating the control unit 111 of the circuit board 11 of the control module 1 to transmit a control signal through the signal adapter 113 to the signal transmission and receiving module 24 and then the control unit 23 of the electric outlet strip 2, for causing the control unit 23 to switch on/off each of the female receptacles 211 on the real time or at a predetermined set time. Thus, a person at the remote side can operate the remote electronic apparatus 30 to control on/off status of the electric products that are connected to the female receptacles 211 of the electric outlet strip 2.

As stated above, subject to setting or editing through an external electronic apparatus 3, the control module 1 is controlled to drive the control unit 23 of the electric outlet strip 2, causing the control unit 23 to switch on/off the female receptacles 211 of the electric outlet strip 2, and therefore installed electric products are turned on/off status subject to predetermined time settings.

In conclusion, the invention provides a power control device, which has the following advantage and features:

1. After the connection of an external electronic apparatus 3 to the connection interface 112 of the control module 1, a user can operate the external electronic apparatus 3 to control the control unit 111 of the control module 1 to make setting, editing and program execution, causing the signal adapter 113 to transmit a control signal to the signal transmission and receiving module 24 of the electric outlet strip 2 for driving the control unit 23 to switch on/off the female receptacles 211 subject to predetermined set times, and therefore the operation time of the electric products that are connected to the female receptacles 211 is effectively controlled.

2. By means of a proximal electronic apparatus 3 that is connected to the connection interface 112 of the control module 1, a person at a remote site can operate a remote electronic apparatus 30 to communicate with the proximal electronic apparatus 3, driving the control module 1 to control on/off status of the electric products that are connected to the female receptacles 211 of the electric outlet strip 2 either on the real time or at predetermined set times.

A prototype of power control device has been constructed with the features of FIGS. 1-6. The power control device allows a person to edit or to set an executing program through an external electronic apparatus so that the control unit of the control module will transmit a control signal through the signal adapter to the signal transmission and receiving module of the electric outlet strip for driving the control unit of the electric outlet strip to switch on/off the female receptacles and the respective connected electric products at predetermined set times.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A power control device, comprising:
an electric outlet strip, said electric outlet strip comprising at least one female receptacle for providing power supply to an electric product respectively connected thereto, a power cable electrically connected with said at least one female receptacle for connection to a power source to obtain power supply, a control unit controllable to switch on/off each said female receptacle and a signal transmission and receiving module adapted for receiving an external control signal for controlling the control unit of said electric outlet strip to switch on/off each said female receptacle; and
a control module, said control module comprising a circuit board, said circuit board comprising a signal adapter unit controllable to provide a control signal to said signal transmission and receiving module of said electric outlet strip for controlling the control unit of said electric outlet strip to switch on/off each said female receptacle and a connection interface for communication with an external electronic apparatus for enabling said external electronic apparatus to control said signal adapter unit in providing a control signal to said signal transmission module.

2. The power control device as claimed in claim 1, wherein said circuit board comprises a control unit selected from the group of CPU, system-on-a-chip, IC and microprocessor and electrically connected with said connection interface and said signal adapter for controlling the operation of said signal adapter subject to the control of the external electronic apparatus being connected to said connection interface.

3. The power control device as claimed in claim 1, wherein said signal adapter of said circuit board comprises a signal input/output port; said signal transmission and receiving module of said electric outlet strip comprises a signal connection port electrically connected to said signal input/output port of said signal adapter.

4. The power control device as claimed in claim 1, wherein said signal adapter unit of said circuit board comprises a wireless transmitting and receiving interface; said signal transmission and receiving module of said electric outlet strip comprises a wireless transmitting and receiving interface for communication with the wireless transmitting and receiving interface of said signal adapter wirelessly.

5. The power control device as claimed in claim 1, wherein the control unit of said electric outlet strip provides a feedback signal to said signal adapter of said control module through said signal transmission and receiving module upon each action to switch on/off each said female receptacle, causing said control module to transmit the feedback signal to the connected external electronic apparatus.

6. The power control device as claimed in claim 1, wherein the control unit of said electric outlet strip is a relay.

7. The power control device as claimed in claim 1, wherein the control unit of said electric outlet strip is a solenoid switch.

8. The power control device as claimed in claim 1, wherein the control unit of said electric outlet strip is a switching device.
